(19) United States
(12) Patent Application Publication
(10) Pub. No.: US 2019/0181407 A1
(43) Pub. Date: Jun. 13, 2019

(54) SHOCK ABSORBANT AND WATER-RESISTANT PORTABLE ENERGY STORAGE DEVICE

(71) Applicant: Romeo Systems, Inc., Vernon, CA (US)

(72) Inventors: W. Porter HARRIS, PASADENA, CA (US); Michael W. PATTERSON, LOS ANGELES, CA (US); Ken VANARSDEL, VANCOUVER, WA (US); Joseph Won Seok CHOI, FULLERTON, CA (US); Andy HUTTON, HAYWARD, CA (US); Jeremy BAKER, PASADENA, CA (US); Dion ISSELHARDT, CARLSBAD, CA (US); Prashanth MORKONDA UMACHANDRAN, ARCADIA, CA (US); Ashish EKBOTE, CERRITOS, CA (US)

(21) Appl. No.: 15/838,224

(22) Filed: Dec. 11, 2017

(51) Int. Cl. H01M 2/10; H01M 10/42; H01M 10/46; H02J 7/00

(52) U.S. Cl. CPC H01M 2/1094; H01M 10/425; H01M 10/46; H01M 2220/30; H02J 7/0042; H02J 7/0013; H01M 2010/4271; H01M 2/1022

(57) ABSTRACT

A portable energy storage device having high-power and high energy capacity can be water-resistant, dust-resistant, and shock-resistant. The device can have an elongated tube-shaped housing.

### CROSS REFERENCE TO RELATED APPLICATIONS

None.

### BACKGROUND

The present disclosure relates to the field of portable energy storage devices and improvements over presently known energy storage devices. Portable energy storage devices are known, capable of charging and discharging energy to and from an internal rechargeable battery system.

Furthermore, known energy storage devices have battery capacities sufficient to charge a typical computer laptop, for example, 40 Watt-hours (Wh) or greater.

Such portable energy storage devices, however, tend to be bulky because they are shaped as substantially rectangular objects, for example, similar to a textbook, to provide spacing and cooling for internal electronics and batteries. Furthermore, for carrying, such energy storage devices are known to have carrying handles because energy storage devices having the capacity to charge typical computer laptops are heavy, for example, 2 lbs or greater.

Such energy storage devices can be difficult to hand-carry because the center of inertia may not lay in a person's palm, regardless of whether such devices have handles.

Similarly, known energy storage devices having high capacity and high-power capabilities tend to have flat rectangular shaped housings that have large exterior surface areas (for example, shaped like a text-book) whereby heat can advantageously be dissipated through.

Such a flat rectangular shape, however, can have storage-related problems. For example, when such rectangular shaped devices are stored in backpacks or messenger bags on-top of books, papers, laptops and tablets, they tend to increase a stack size of the various stored objects which results in bulging or overstuffed bags.

Furthermore, it is advantageous for energy storage systems to provide high speed charging and discharging, for example, charging rates from 57 W and discharging rates greater than 160 W (combined outputs). Such power capabilities, however, generate significant heat from power loss. Furthermore, a compact design reduces spacing between components, which tends to exacerbate the heating conditions.

Therefore, known portable energy storage devices have openings, for example, air vents, to provide air circulation for cooling and/or larger form factors to increase spacing between components.

Vents or openings, however, can allow water to enter the device. Therefore, providing a water proof energy storage device without vents is advantageous, but creates heat transfer challenges such as removing heat generated by electronics and batteries when charging and discharging. In other words, challenges arise to develop a water-resistant energy storage device with fast-charging, high power and high battery capacity capabilities because providing for water resistance tends to require hermetic or water-tight sealing, which tends to trap heat.

In addition, vents and openings can provide a pressure release especially in the case of battery failures and/or thermal runaway which can result in high temperatures and pressures internal to the device. Therefore, providing a waterproof device without vents and openings is an additional challenge due to trapped pressure.

Furthermore, portable energy storage devices tend to have increased risk of drops and collisions due to transportation between locations, being kicked, or knocked over. In addition, high-capacity storage devices require significant batteries which increase the mass of the product. Such increase in mass and weight increases the risk of damage from mechanical shock. Therefore, high-capacity devices should provide shock absorbing capabilities to protect internal components such as electronics, batteries, mechanical structures and more. However, providing for shock absorbing capabilities may be challenging in compact energy storage devices because shock absorbing elements tend to take up space.

Furthermore, portable energy storage devices having low capacities and/or low power capabilities do not face comparable problems due to the lower heat generation, lower volume, and lower weight/mass of smaller devices.

### SUMMARY

The present disclosure relates to an energy storage device having a rechargeable battery system with a capacity of 40 Watt-hours (Wh) or more. In particular, this disclosure identifies and addresses deficiencies that are present in the field of high-capacity, high-power, portable energy storage devices.

According to a first aspect, a portable energy storage device is described as having: a rechargeable battery system having one or more rechargeable batteries with a combined energy capacity of 40 Wh or more; one or more input electrical connectors and one or more output electrical connectors; and a water-resistant elongated tube-shaped housing, the housing having a top end, a bottom end, and a height that is at least three times that of a width and a length of the housing.

According to a second aspect, a portable energy storage device according to the first aspect is described, wherein the housing is a vent-less housing, without openings other than a screen-covered pressure-vent.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

FIG. 1A shows an exploded view of an energy storage device according to the present disclosure.

FIGS. 1B and 1C shows additional views of an energy storage.

FIG. 2A shows an exploded view of a bottom housing assembly.

FIG. 2B shows an additional view of a bottom housing assembly.

FIG. 3A shows an exploded view of a top housing assembly.

FIG. 3B shows an additional view of a top housing assembly.

FIG. 4A shows an exploded view of a skeleton bracket and other components.

FIG. 4B shows an additional view of a skeleton bracket and other components.

FIG. 5A shows an exploded view of an inverter assembly.

FIG. 5B shows an additional view of an inverter assembly.

FIG. 6A shows an exploded view of the inverter assembly relative to other components.

FIG. 6B shows an additional view of the inverter assembly relative to other components.

FIG. 7 shows a system level diagram of the energy storage device.

FIG. 8 shows an example of how the energy storage device can be stored relative to other stored objects.

FIG. 9 shows an example of how known energy storage devices are stored relative to other stored objects.

FIG. 10 shows an exploded view of a button assembly.

FIG. 11 shows a lanyard.

FIG. 12 shows an exploded view of the soft cover at the bottom housing.

FIGS. 13A and 13B shows the soft cover at the top housing.

### DETAILED DESCRIPTION

Definitions

A “break-away fastener” is a fastener that, provided with a threshold amount of force, will yield, for example, an adhesive. Typically, screw fasteners are not break-away fasteners because they do not generally permit planned failure modes and would require an excessive force to overcome.

“Charging” and “discharging” as used herein, unless the context requires otherwise, is from the perspective of the energy storage device. Therefore, “charging” means the device is receiving energy, and “discharging” means the device is delivering energy.

“Fluid connection” means a fluid path between two points, not being cut off from or separated from.

A “high-power” device, as used herein, describes energy storage devices capable of charging at 57 watts or greater, and 160 watts or greater of discharging.

A “high-capacity” or “high-energy” device as used herein describes energy storage devices having 40 Wh or more.

“Soft” as used herein means capable of being easily compressed. For example, silicone gels are soft.

“Stiff” as used herein means rigid and not easily bent. For example, a 1″ metal pipe is stiff, however, a thin metal foil is flexible.

“Ventless” or “without vents” or “without openings” as used herein relates to not having openings or vents for cooling or other purposes. This excludes, however, pressure vents, screens, or openings equal to or smaller than 2 mm in diameter covered with screens, that provide for internal pressure adjustments. Such pressure adjustments, for example, may be useful when traveling in airplanes or other situations where pressure changes in the environment occurs.

“Charge controller” and “DC controller” as used herein are synonymous and relate to electronic components, such as resistors, capacitors, transistors and FETs, that work together to convert an input DC voltage input to a DC voltage output, the output delivered to rechargeable batteries for charging.

“Communication” as used herein, unless otherwise stated, describes either a known communication protocol, for example, UART, CAN, I²C, SMB, or a simple hardwired analog or discrete signal, for example, one or more digital or analog I/O.

Descriptions herein relating to dimensions, such as shapes, ratios, lengths/widths/heights, and more, are approximations and are intended to include a range, for example, within a 10% margin of error.

### System Description

As discussed, various challenges arise in designing a compact portable energy storage device having high power charging and discharging capabilities, and high capacity. The following contains a detailed description of a portable energy storage device various, including embodiments and features of the present invention that address the various problems identified herein.

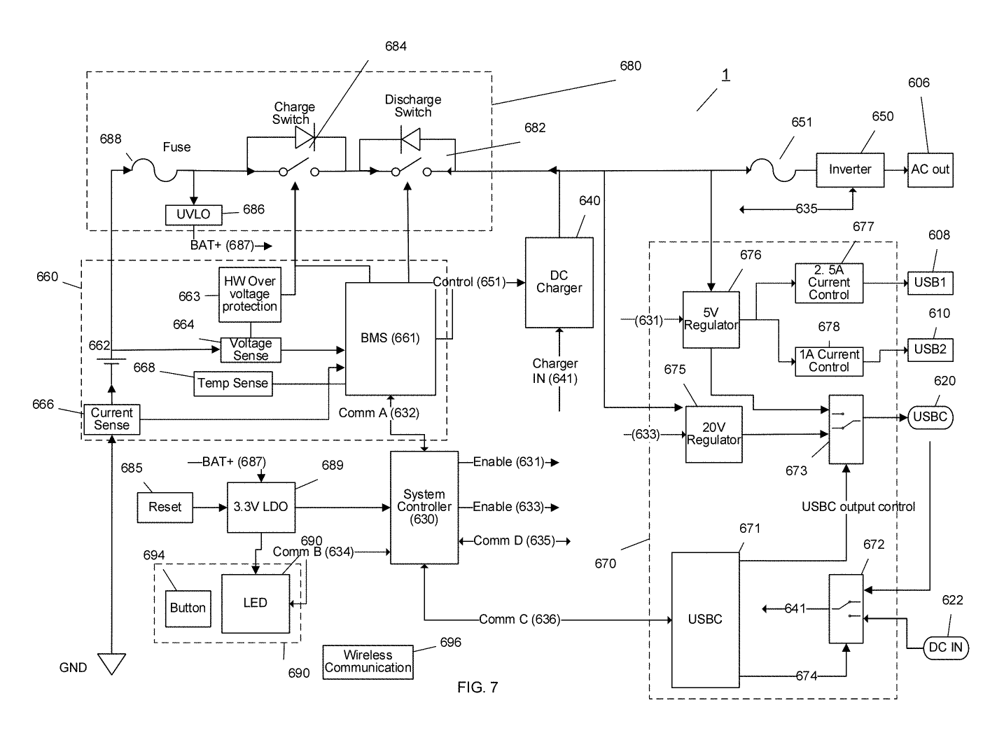

As shown in FIG. 7, a system-level view of a portable energy storage device 1 according to the present disclosure can include electronic components, systems, microprocessors, and sensors that provide energy storage and charging. The system level components described herein can contain, for example, known electronic components, integrated circuits, semi-conductor devices, power switching semi-conductors, and/or microprocessors, capable of being arranged and programmed by one skilled in the art.

### Battery System

A battery system 660 is shown having a battery management system (BMS) 661 and rechargeable batteries 662. The BMS can include a microprocessor, memory storage, a programmable logic device, or other comparable electronic component, configured to manage and control a charging and discharging of the one or more batteries.

The rechargeable batteries 662 can have a total energy capacity of 40 Wh or more. In particular, the rechargeable batteries can have a total energy capacity of 85 Wh or more. More preferably, the rechargeable batteries can have a total energy capacity of 86 Wh. The rechargeable batteries can include six or more 18650 batteries. In particular, the rechargeable batteries can include eight batteries and weigh 2.2 lbs. In this case, the batteries can be connected 4 in series and 2 in parallel.

Advantageously, an 86 Wh battery pack can charge two or more typical laptops, 10 phones, or 2-4 tablets. As stated above, however, a large battery pack increases weight/mass, increases potential damage from shock, and creates packaging problems.

Each battery can have a voltage of 3.5V and capacity of 3070 mAh. Each battery can be a low Direct Current Internal Resistance (DCIR) battery cell, for example, having an internal resistance of 20 mOhms or less under IEC 61960 standards (discharge at 0.2 C for 10 seconds and discharge at 1 C for 1 second) and/or ISO 12405 standards (discharge at 1 C for 18 seconds, then 0.75 C for 102 seconds, rest, then charge at 0.75 C for 20 seconds, and rest).

Low DCIR battery cells, although higher cost, can provide faster charging of the batteries. Indeed, the device according to the present disclosure can fully charge the internal batteries in 1 hr and 45 minutes, which is twice as fast as known comparable devices, at least due to the low DCIR battery cells and the thermal systems (for example, the flexible heat transfer sheet and heat sink) described herein.

The battery system 660 can include a hardware (HW) over voltage protection system 663 that monitors the voltage of the rechargeable batteries 662 from a voltage sense 664.

The BMS also monitors the batteries through the voltage sense 664, the temp sense 668 and the current sense 666. The temp sense can include thermistors or other known temperature sensing devices, located on the battery and/or in other locations of the device. The voltage sense 664 can monitor the voltage of each individual cell and/or the rechargeable battery pack, as a whole (the total series voltage). The current sense 666 can be a hall-effect current sensor, a current shunt, or other known current sensing devices.

The BMS can have a Communication A 632 connected to the System Controller 630 for data sharing and combined decision making. Communication A can be a communication bus, for example, an SMB or IC² or other known electronic communication protocol.

The BMS can also connect to the charge switch 684 and discharge switch 682 to safely disconnect the battery 662 DC regulators 676 and 675 and inverter 650.

### Protection and Isolation Unit

The device can include a protection and isolation unit 680, including the discharge switch 682, the charge switch 684, an under-voltage lockout circuit (UVLO) 686 and a fuse 688, connected as shown in FIG. 7. Indeed, the configuration of the charge and discharge switch allows protection of the BMS and HW overvoltage protection system to isolate the battery from input currents during overvoltage by opening the charge switch. Similarly, the same circuit can independently isolate the battery from discharging by opening the discharge switch.

As shown in FIG. 7, the HW overvoltage protection can be connected to a charge switch 684, such that when the battery voltage is too high, the HW overvoltage protection can command the charge switch 684 to open.

The direction of the charge switch diode prevents current from flowing into the batteries when the switch is open. However, the charge switch diode advantageously provides for current to flow towards electronics to deliver power to the electrical outputs when the switch is open, so long as the discharge switch 682 is closed.

Similarly, the BMS 661 can be configured to open the discharge switch, for example, if a problem is detected at the outputs, or if the battery voltage or stored energy is too low. When the BMS opens the discharge switch, the batteries are disconnected from the outputs, however, the discharge switch diode allows for charge currents to the battery so long as the charge switch remains closed.

The charge switch 684 and the discharge switch 682 can be relays, semiconductor switching components, or other known switching devices, with diodes connected in parallel with the switch, as shown in FIG. 7.

The UVLO 686 monitors the battery voltage and connects the battery voltage (Bat+) 687 to the 3.3V Low Drop-out (LDO) 689 circuit. In the case of an over voltage, the UVLO can disconnect the Bat+ from the LDO. The threshold for over voltage is an unacceptable high voltage, determinable by one skilled in the art based on the battery cells in the device.

Similarly, when the input to the LDO regulator is below a voltage threshold, the LDO will shut off the output voltage to the System Controller 630, thereby shutting off the outputs to the inverter and USB ports and advantageously preventing further draining of the batteries. Similarly, the threshold for under voltage is an unacceptable low voltage, determinable by one skilled in the art based on the battery cells in the device.

A reset module 685, for example, a button, can connect to an input of the LDO, thereby advantageously providing a feature of resetting the System Controller 630.

A DC battery fuse 688 can be connected as shown to provide additional protection.

### DC Charger

The DC charger 640 can include electronic power switching devices, gate drive circuits, integrated circuits, and other electronic components. The BMS 661 can have a control command 651 connected to the DC charger to turn the DC charger on or off.

The Charger can receive a DC input 641 from either the DC input 622 or the USB type-c receptacle 620, depending on the situation, as described further below. The charger can convert a DC voltage from a DC electrical input 622 to charge the batteries 662.

### User Interface and Inverter

The device can include a user interface 690, having one or more buttons 694, one or more LEDs 692, and electronics configured to power, maintain, and control the state of the one or more LEDs. The user interface 690 can include integrated circuits and/or processors, configured to communicate with the System Controller 630 through a Communication B 634, for example, I²C.

The inverter 650 can include electronics and a controller, configured to convert a dc voltage from the batteries to an AC voltage output to an AC output connector 606. The output connector 606 can advantageously be a universal AC receptacle.

The inverter system can provide an AC output of 90 W (for example, 120 VAC at 0.75 A).

An inverter fuse 651 can be connected as shown to provide additional protection from an overcurrent.

Advantageously, by providing an onboard inverter, the portable device can behave as a mini-grid, capable of behaving as a standard wall outlet. Inverters, however, typically create heat during operation, which can present problems, especially in the case of water-resistant, vent-less products.

Accordingly, the inverter system 650 can have a modified sinusoid inverter or a pure sinusoid inverter. Advantageously, such inverters have lower heat generation/loss but require more effort for development and higher economic cost. Modified sinusoidal inverters and pure sinusoid inverters increase production costs due to added control complexity and electronic parts, but generate lower heat.

The inverter system can be configured to communicate with the System Controller 630 over Communication D (635) and to respond to on/off commands from the System Controller. In this case, the System Controller can be configured to send on/off commands based on information from the user interface 680.

For example, the System Controller can be configured to turn the inverter on and off based on a button press or a sequence of button presses. Advantageously, the user (through the user interface and the System Controller) can actively manage the inverter by turning it on only when being used. This reduces the overall heat loss and increases energy efficiency when no exterior devices are connected to the AC output 606.

Furthermore, button sequence detection potentially minimizes the component count and design complexity by assigning multiple functions for each button. Advantageously, the user interface 680 can utilize even a single button for multiple commands, simply based on sequence and timing of button presses.

### USB Charging and Discharging

The device can include USB connections 608, 610, and 620. A USB support system 670 can include electronics and/or software configured to provide USB charging and discharging capabilities.

For example, a USB-type C receptacle 620 can support both input (charging) and output (discharging) at 15 W at 5V, and/or at 60 W at 20V. A USB type-C controller (USBC Controller) can provide an output control signal to an output MUX 673 to toggle the USB type-C connector output voltage between 5V and 20V, supplied by voltage regulators 631 and 633, respectively. Voltage regulator 633 can be a DC to DC switching regulator, thereby boosting the battery output voltage, for example, to 20V.

The voltage regulators can be turned on and off by the System Controller through enable lines 631 and 633, respectively.

Furthermore, the USBC Controller can send a command to an input MUX 672, thereby toggling a Charger input 641 between the USBC receptacle 620 and a DC input 622. The MUXs can include electronic components, such as FETs or transistors, arranged in known configurations by persons skilled in the art.

The USBC Controller 671 can, in turn, be controlled by the System Controller 630 through a Communication C 636. Communication C can be, for example, I²C or other known communication protocols.

A 5V regulator 676 and 20V regulator 675, can connect, respectively, to current controllers 677 and 678. The current controllers 677 and 678 can monitor and control the current output from the regulators into the connectors 608 and 610, thereby providing a level of protection in the case of an overcurrent or short-circuit.

USB output receptacles 608 and 610 can be configured to connect to and charge USB capable devices, for example, mobile devices and tablets, and charge such devices at 5V up to 10.5 W.

### Wireless Connection System

The device can include a wireless connection system 696, for example, Bluetooth, zigbee, Wifi, or other known wireless connection systems. The wireless connection system can include one or more transmitters, receivers or transceivers and one or more processors. Similarly, the wireless connection system can share a processor with other systems, for example, the System Controller 630, the bms 661 or other processors on board that can support wireless communication.

### Form

Based on the various system features described above, mechanical and thermal challenges arise or are exacerbated. Packaging such features in a water-tight, dust-proof, compact, and shock-resistant device is a challenge at least due to the mass of the batteries, the heat generated from the inverter and charger, and the user interface.

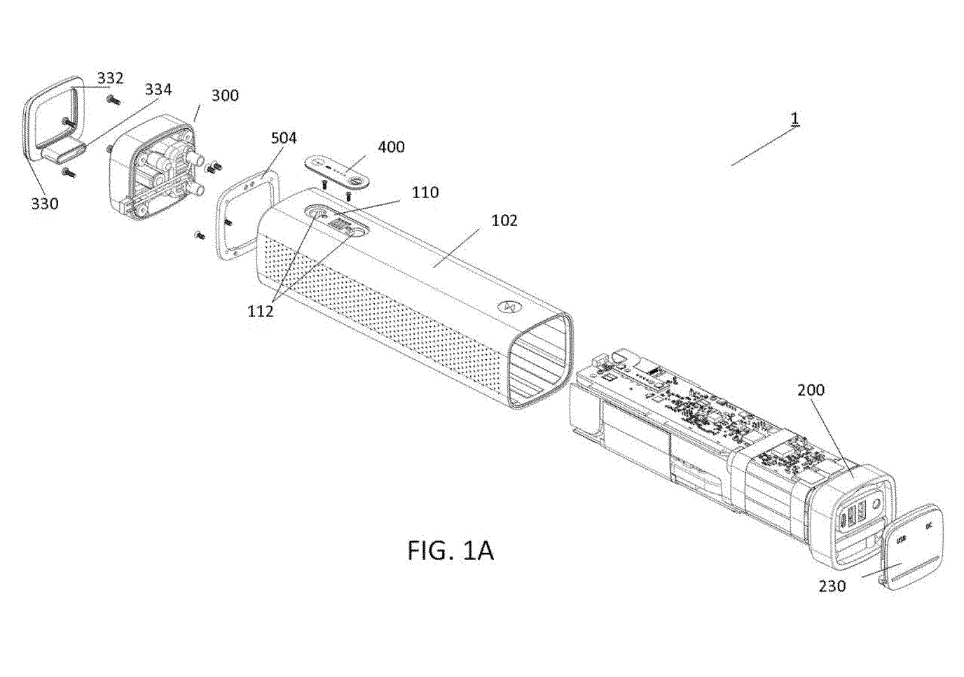

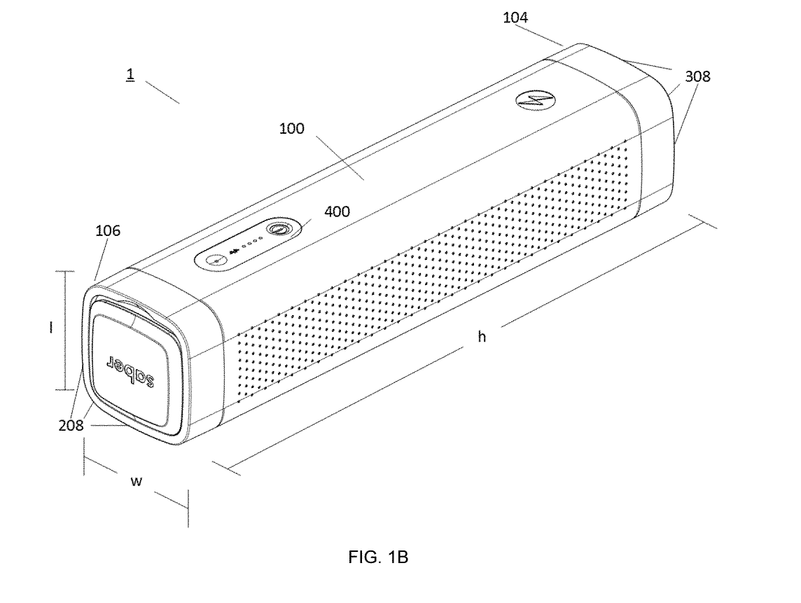

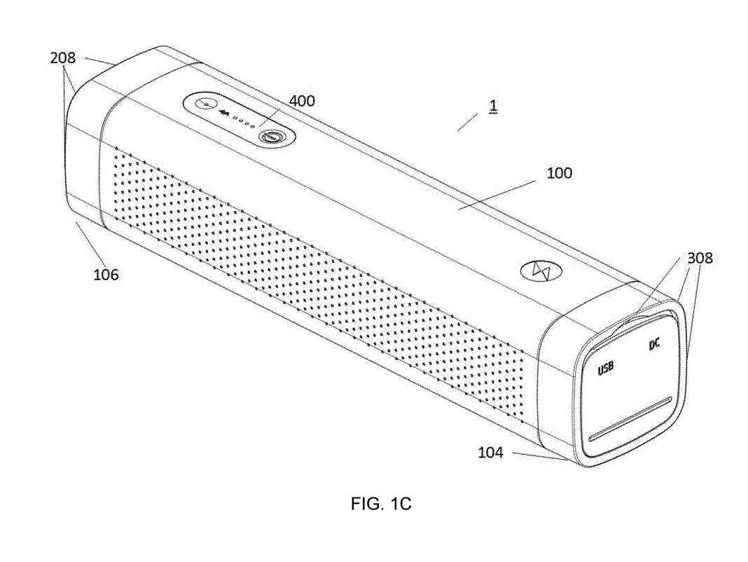

As shown in FIGS. 1B, and 1C, a portable energy storage device 1 is shown having an elongated tube-shaped housing 100. In particular, FIGS. 1B and 1C show that the tube-shaped housing has a bottom end 104 and top end 106. The ends can have flat faces, as shown in FIGS. 1A, 1B, and 1C, or contoured surfaces.

The bottom end 104 and top end 106 describe geographic locations of the housing 100, as opposed to specific components. Furthermore, FIG. 1A shows an exploded view where the housing 100 includes three parts, a central housing body 102, a top housing assembly 300 (located at the top end) and a bottom housing assembly 200 (located at the bottom end).

A tube-shaped housing is understood to include a three-dimensional housing that is substantially longer in a dimension ‘h’ than in two remaining dimensions, ‘l’ and ‘w’. Preferably, the elongated tube-shaped housing has a height that is at least three times that of a width and a length of the housing. More preferably, the width and the length from 2 to 3 inches.

Such an elongated shape advantageously provides sufficient internal volume to house required electronics and batteries, while maintaining an ergonomic form factor. In particular, the device having an elongated tube-shaped housing is capable of being held and gripped, comfortably, in the palm of a hand. For example, in contrast to large rectangular (book-shaped) devices, the inertial center of the device can be gripped in the palm of the hand, thereby reducing swinging movements when held and transported.

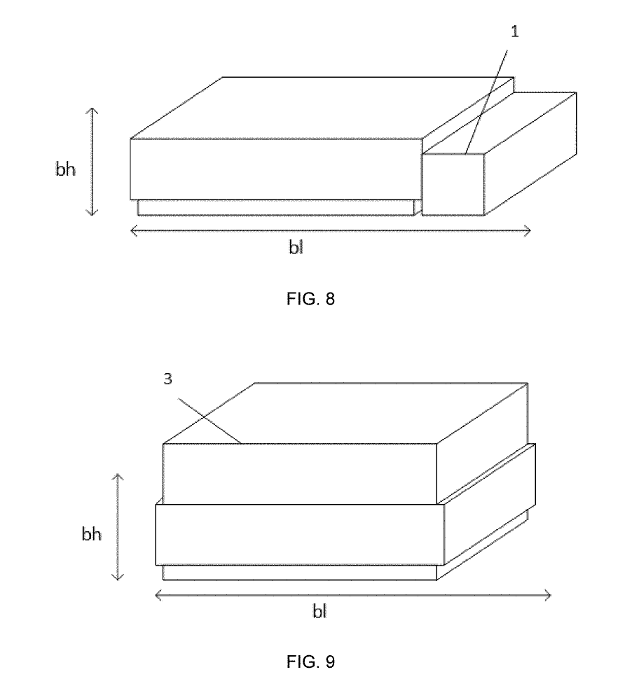

Furthermore, the elongated tube-shape of the device 1 can fit in student backpacks, messenger style bags and briefcases alongside stacked books, laptops, and tablets, as illustrated in FIG. 8, thereby taking space along a bag length ‘bl’ rather known high-energy storage devices 3 that stack on top of books, laptops, and tablets along a bag height ‘bh’ as illustrated in FIG. 9. The tube-shaped device can also advantageously fit in cup-holders or other narrow spaces.

Additionally, the tube-shaped device can more easily slide in and out of a space in a bag, thereby being the device easier to grab, carry, and put back, as compared with other shapes.

The elongated tube-shaped housing can have different cross-sectional polygons. For example, the cross section can be a circle, oval, or polygon such as a square, rectangle, pentagon, or others. In particular, the elongated tube-shaped housing can be rectangular with rounded corners, throughout the entire height of the device.

Advantageously, the rounded corners provide for improved comfort for gripping, and the rectangular or square cross section provides an adequate internal volume to space heat generating components, especially where the length and width are from 2 to 3 inches.

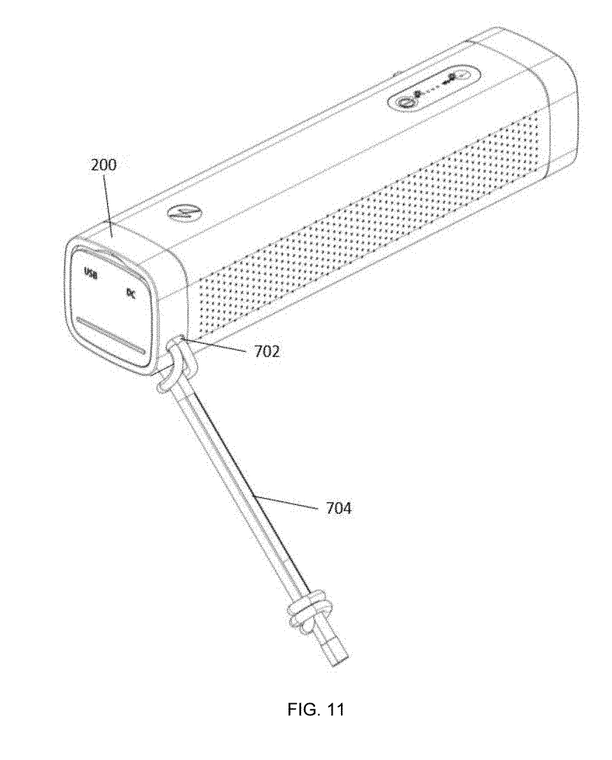

Additionally, as shown in FIG. 11, the inlet end body or outer end body can also have a lanyard location. Lanyard location may have a channel 702 through a corner of the bottom housing 200 to house a rope 704. The lanyard can provide additional support when the device is being gripped, by first looping the lanyard around the holder's wrist. In addition, if the holder accidentally releases or softens her grip, the lanyard can prevent the device from slipping out of the holder's hand and falling to the ground. The lanyard also provides a simple means to hang the device on, for example, a hook.

Such a compact form, however, creates additional considerations regarding heat because of a reduced surface area for heat dissipation, which is further addressed herein.

In addition, although compact, the device can have a weight of 1.5 lbs or greater, for example, the disclosed device having an 86 Wh battery pack can have a weight of 2.2 lbs.

### Water-Resistance and Dust-Resistance

The housing 100 can be a vent-less housing, without openings. A vent-less housing advantageously provides improved water-resistance. A vent-less housing, however, provides heat-transfer challenges because charging and discharging of batteries under high power. For example, charging from the DC input 622 at 57 W (19V at 3.4 A) and discharging at 90 W through the universal AC receptacle (120 VAC at 0.75 A) for prolonged periods of time generates heat that can be trapped if not moved away from the components.

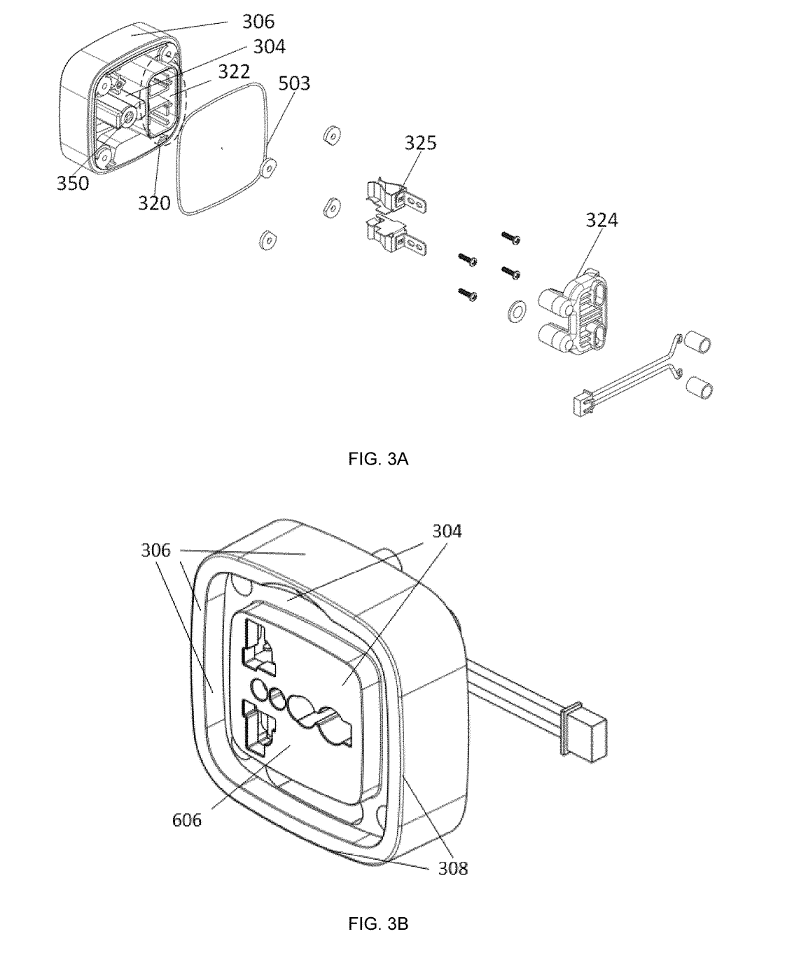

In addition, due to the vent-less housing, differences in the ambient pressure and an internal pressure of the device can become significant and cause failures to the various seals and parts of the housing. Therefore, FIG. 3A shows the device can have a pressure vent 350. Pressure vent 350 can include one or more openings having a diameter of 1.5 mm or less.

Furthermore, a screen, for example, an expanded PTFE membrane, screen, or filter, can be fixed over the openings. In this regard, the pressure vent provides pressure equalization, for example, when the device is taken on an airplane or undergoes similar large pressure changes, thereby mitigating risk of damage to the device caused by pressure differences. Furthermore, the relatively small size of openings covered by the screen prevents dust and liquid from entering the device.

As shown in FIG. 1A, the housing 100 can include a central housing body 102, a bottom housing assembly 200 located at the bottom end 104 of the housing and a top housing assembly 300 located at the top end of the housing. The top housing assembly can connect to the central housing a top edge of the central housing body through a first water-tight connection 110. Similarly, the bottom housing assembly can connect to the central housing body at a bottom edge of the central housing body through a second water-tight connection 120. Importantly, the top housing assembly and bottom housing assembly are fixed to the central housing body and are not removable or detachable once assembled, for example, by twisting or turning of a threaded connection. This prevents users from opening the device and defeating the water and dust resiliency of the device. In other words, the top housing assembly and bottom housing assembly are not connected to the central housing body through a threaded connection.

As shown in FIG. 1A, the central housing body 102 can be a monolithic stiff member, thereby reducing the chance of water entering the device. Furthermore, the housing 100 can be a fin-less housing, having a smooth exterior surface, free of protrusions, projections, and bulges. Advantageously, this provides for improved ergonomics and storage in confined and shared spaces, and better for sliding in and out of spaces.

The top housing assembly 300 can fasten to a top end bracket 504, the top end bracket mechanically fastening to a skeleton bracket 500, thereby forming the first water-tight connection by sandwiching a top gasket ring 503 (shown in FIG. 3A) between the central housing body and the top housing assembly.

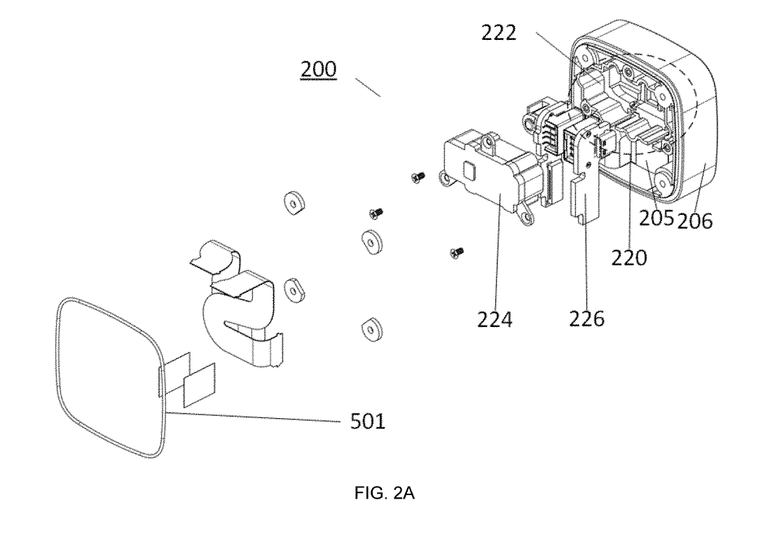

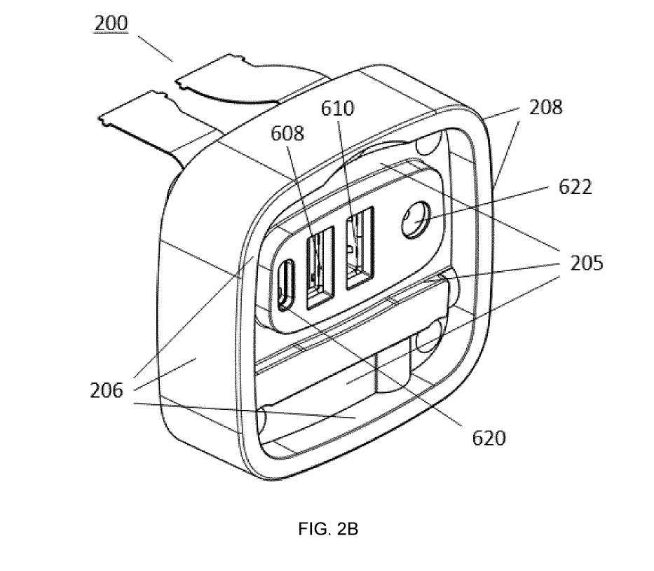

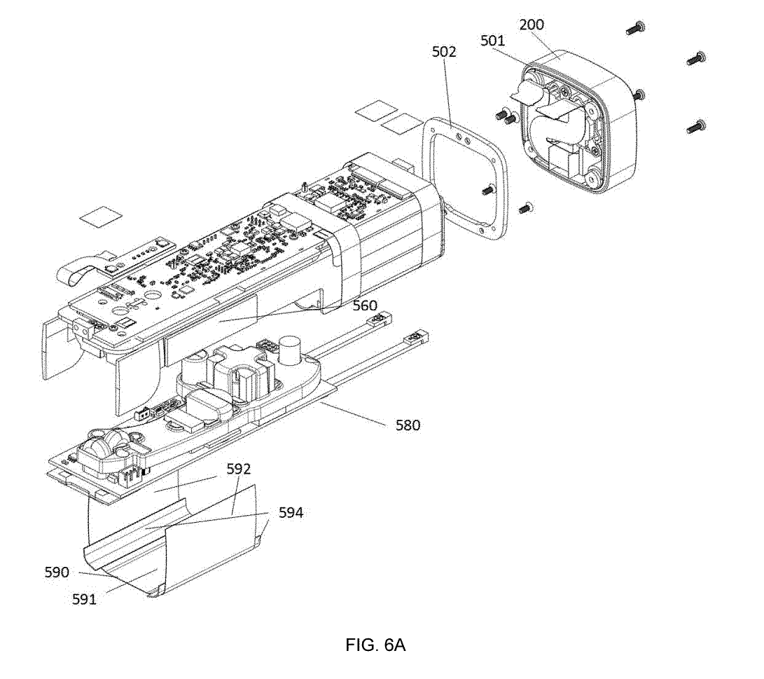

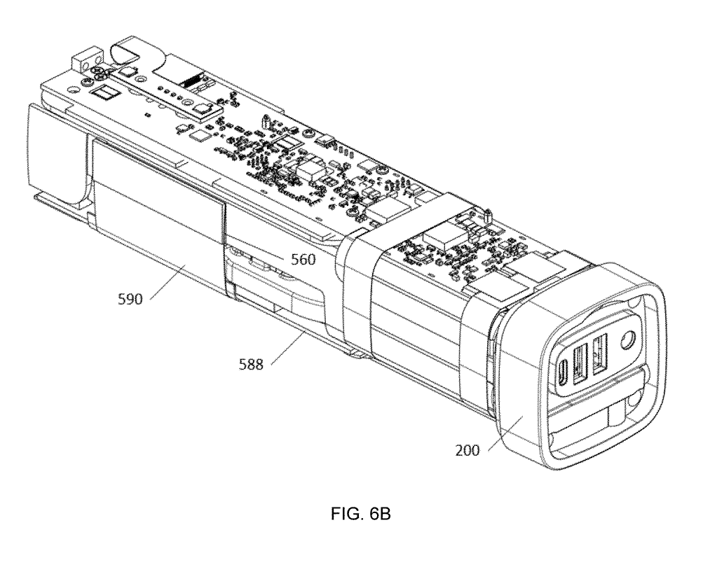

Similarly, as shown in FIG. 6A, the bottom housing assembly 200 can attach to a bottom end bracket 502 which can attach to the skeleton bracket, thereby forming the second water-tight connection by sandwiching a bottom gasket ring 501 (also shown in FIG. 2A) between the bottom housing assembly and the central housing body.

The attachments between the end brackets and the skeleton bracket can be made by traditional means known by one skilled in the art, for example, by screws.

Referring to FIG. 3A, the top housing assembly 300 can have a potting zone 320. Similarly, the bottom housing 200 can have a potting zone 220 as shown in FIG. 2A.

The potting zones 320 and 220 can include respective potting cups 322 and 222, located on an interior portion of top housing and bottom housing, respectively, shown in FIGS. 3A and 2A. Potting material is disposed in the potting cups resulting in water-tight seals behind the connectors to advantageously prevent water from entering the device through the connectors. A potting material can be selectable by one skilled in the art to maintain a water-tight and dust-tight seal.

Furthermore, the potting zones can include respective potting masks 324 and 224. The potting masks can be stiff members that attach to locations of the respective potting zones, configured to hold and secure electrical connectors and assemblies (226) and/or electrical conductors and contacts (325), for example, in grooves or slots, while a potting material is disposed in the respective potting cups.

In this manner, the potting zones can be co-located with one or more input electrical connectors, for example, a USB type-C input/output 620, and/or a DC voltage input 622. Similarly, the potting zones can be co-located with one or more output electrical connectors, for example, a universal AC receptacle 606, a first USB connector 608, a second USB connector 610, and the USB type-C input/output 620. The potting zones described provides an IP67 and/or a water-tight seal at the one or more input electrical connectors and/or the one or more output electrical connectors.

For example, FIG. 2A shows a connector assembly 226 having USB connectors and a DC input connector, the connector assembly being housed in the potting cup 222, and a potting mask 226 mounted over the potting cup through screws.

Similarly, FIG. 3A shows a potting mask 324 attaching to the top housing assembly over the potting cup 322 and electrical contact springs (325) that fit into grooves in the potting cup 322.

Advantageously, as shown in FIG. 1A, a three-part housing configuration consisting of a central housing body 102, a bottom housing assembly 200, and a top housing assembly 300, provides an elegant solution to preventing water from entering the device. The three parts fit together in water-tight seals formed by gaskets, and the top and bottom assemblies provide an accessible area for connectors to be disposed and potted on.

As shown in FIGS. 3A, 3B and 2A and 3B, the top housing assembly and the bottom housing assembly can each have respective soft covers 330 and 230 that are partially fixed to the respective top housing and bottom housing and partially removable, by hand, to provide access to the one or more input electrical connectors and the one or more output electrical connectors.

The soft covers and the respective top and bottom housings can have complementing forms to provide a removable and attachable water-resistant seal through mating when pulled apart or pressed together. In other words, because the soft covers 330 and 230 are soft, they can be pressed into and mated with top housing and bottom housing, thereby providing additional water-seal protection.

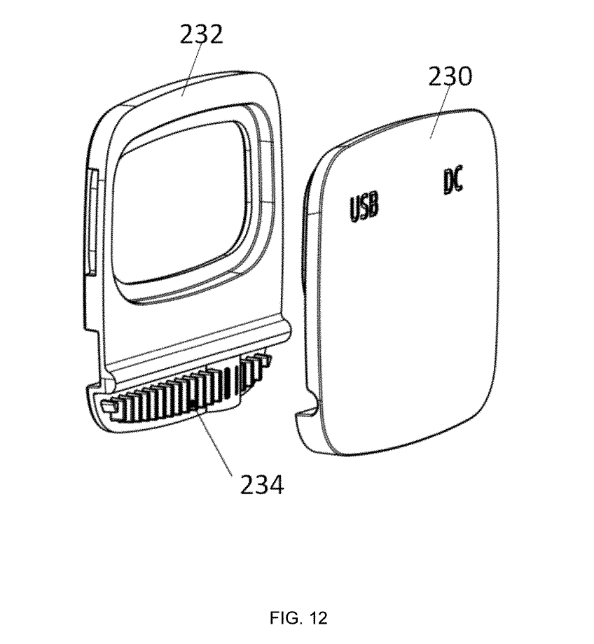

FIG. 12 shows a soft-cover 230 fixed to an intermediate hard cover 232, at only a portion 234 of the hard cover 232. The portion 234 can have jutting teeth or bumps that mate with corresponding channels of the soft-cover 230, bonded together with an adhesive, thereby creating a strong bond.

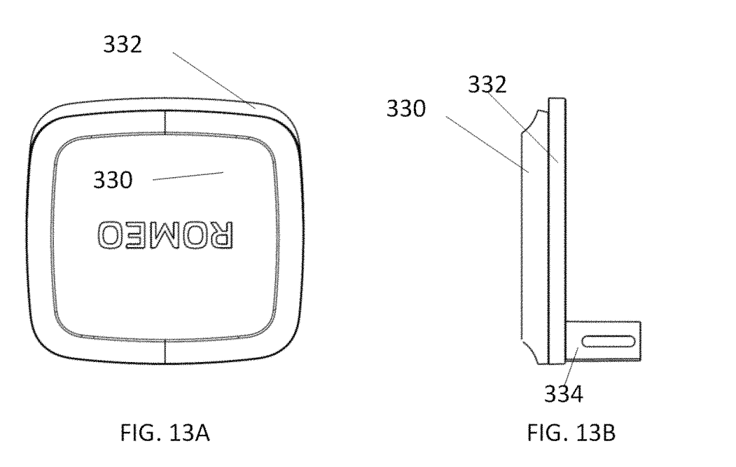

Similarly, FIGS. 1A, 13A, and 13B show the softcover 330 connected to an intermediate hard cover 332. The intermediate hardcover 332 can, in turn, be fixed onto the top housing 300 by an adhesive. In this case, the softcover 330 can have a latching arm 334 housed in and through the body of the intermediate cover 332. Advantageously, the latching arm keeps the softcover from being completely removed from the device, but permits the soft cover to travel completely off the face of the intermediate cover, while remaining latched to the intermediate cover through the arm. The opening permits a user to open and insert a plug into the AC receptacle 606.

Also shown in FIG. 3A the pressure vent can be covered by a co-located soft cover, described above, to prevent water from entering the device through the pressure vent.

Indeed, during testing, the described device survived water submerging and operated successfully once the electrical connectors are dry at least because of the water-tight seals of the housing, the potted connectors, and the soft covers. Similarly, the device was tested successfully in dust-heavy environments.

Furthermore, the device is capable of withstanding environments according to IP67 and IP66.

### Heat Transfer

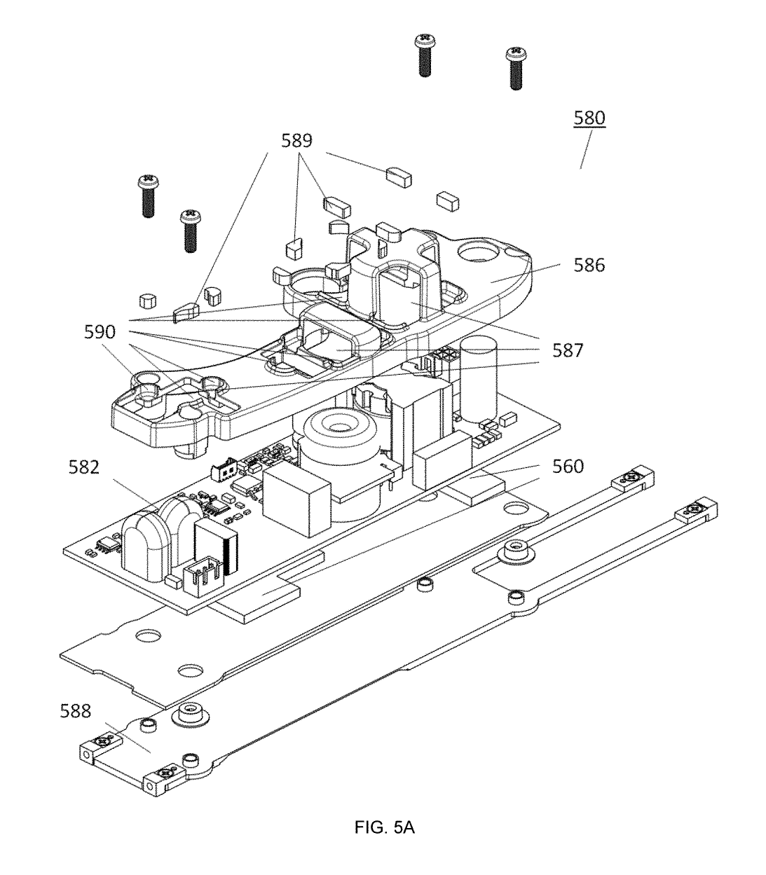

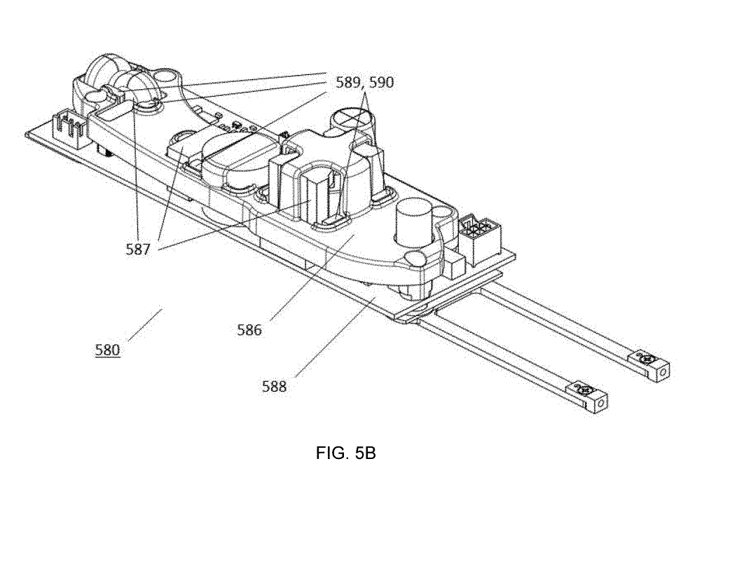

Referring now to FIG. 5A, the device can include an inverter assembly 580, the inverter assembly including an inverter PCB 582 having inverter components (e.g. electronic components) mounted on the PCB. The inverter assembly can include an inverter heat sink plate 588 thermally connected to heat generating components of the inverter assembly. The inverter heat sink plate can be a flat, elongated plate without fins. Advantageously, a fin-less heat sink takes up less space than a heat sink with fins. Furthermore, because the device is vent-less and does not rely on internal airflow for cooling, fins would not help dissipate heat. Inverters, however, tend to generate substantial amounts of heat.

In this regard, the inverter assembly 580 can have a pure or modified sinusoid inverter to reduce the heat generation/loss.

Furthermore, FIGS. 6A and 6B show a flexible heat transfer sheet 590, for example, a graphite sheet, thermally connected to the inverter heat sink plate and thermally connected to the housing. A center portion 591 of the graphite sheet can connect to the heat sink, and two side portions 592 of the graphite sheet can wrap around the internal components and thermally connect with the housing, thereby transferring the heat from the inverter to the housing.

Graphite sheets are particularly advantageous to use, due to their high heat conductivity and high flexibility.

Referring to FIG. 6B, shock absorbing layers 560 or equivalent spring-like layers can be positioned between the internal components (for example, the skeleton bracket) and the heat transfer sheet to exert a gentle pressure on the heat transfer sheet to maintain a solid contact between the heat transfer sheet and the housing.

Referring to FIG. 6A, the heat transfer sheet can have one or more sheet stiffeners 594, the stiffeners helping to maintain the form and shape of the heat transfer sheets maintain a sold contact between the heat transfer sheet and the housing. In particular, because of the tube-shaped design of the device, the curvatures of the interior of the housing presents challenges for heat transfer. The stiffeners help form one or more curves in the sheet to match the inner contours of the housing, for example, by forming one or more rounded corners.

In this regard, the heat transfer sheet is particularly helpful over traditional means because the sheet is flexible and can wrap around the components in a confined space, and additionally, also contact the housing to transfer heat away from the electronics and into the housing.

Furthermore, the device can be a fan-less device, not having any internal fans, due to the techniques described herein.

Indeed, the disclosed device is capable of continuous operation at 0 to 40° C., at 160 W power output.

### Button Assembly

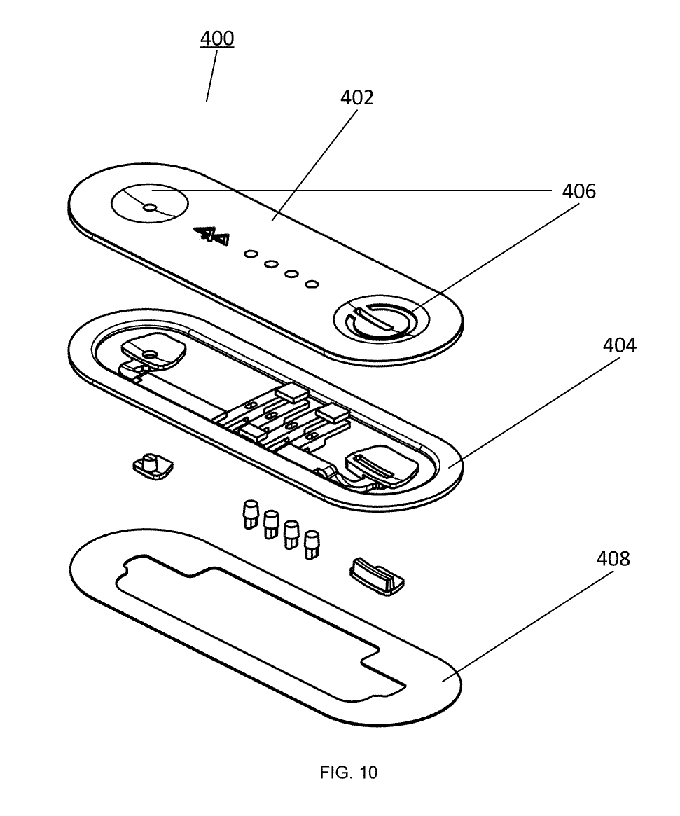

Referring to FIG. 1A, the device can include a button assembly 400 disposed on a button zone 110 of the housing. FIG. 10 shows the button assembly including a button membrane 402, a stiffening member 404, and one or more buttons 406 located beneath the button membrane 402. For example, the stiffening member can have a ring shape, located along a perimeter of the button membrane.

Advantageously, the stiffening member prevents the button membrane, which can be made from a soft durable material (for example, a silicone based polymer, rubber, or synthetic rubber), from warping. Warping can detrimentally create openings between the button membrane and the housing, thereby increasing the risk of water to enter.

The button zone of the housing can have one or more openings 112 through the housing, where the openings are located directly below the button assembly. Furthermore, the one or more openings are can be in fluid connection with the one or more batteries and the one or more openings can be sized to provide an emergency pressure outlet. In this case, the button assembly can be fastened to the housing with a breakaway fastener, for example, an adhesive bond layer 408, thereby providing an emergency pressure release for the device. The openings can be sized, for example, from ¾″ to 1/10″, or selected based on the application by one skilled in the art.

In particular, this is advantageous because rechargeable batteries can have failure modes, for example, thermal runaway, that can generate high pressure. The pressure will then predictably be released through the openings beneath the button assembly by forcing an opening between the button assembly and the housing.
Although traditional screw fasteners provide numerous benefits over the adhesive/breakaway bond, such as reliability, ease of manufacturing, and potentially lower cost, such screw fasteners may not reliably and predictably yield under a force. Therefore, traditional screws are not used to fasten the button assembly to the housing with the breakaway button assembly.
This feature allows the button assembly to blow out in the case of a failure, thereby releasing internal pressure in a controlled manner before the pressure builds to a point of explosion.

### Shock-Resistance

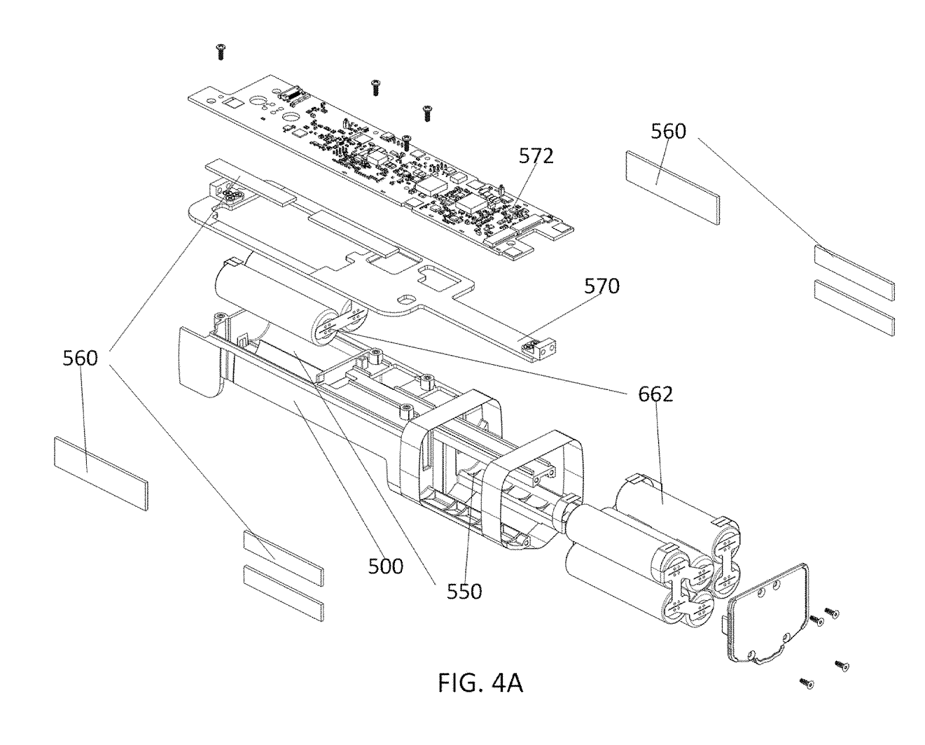

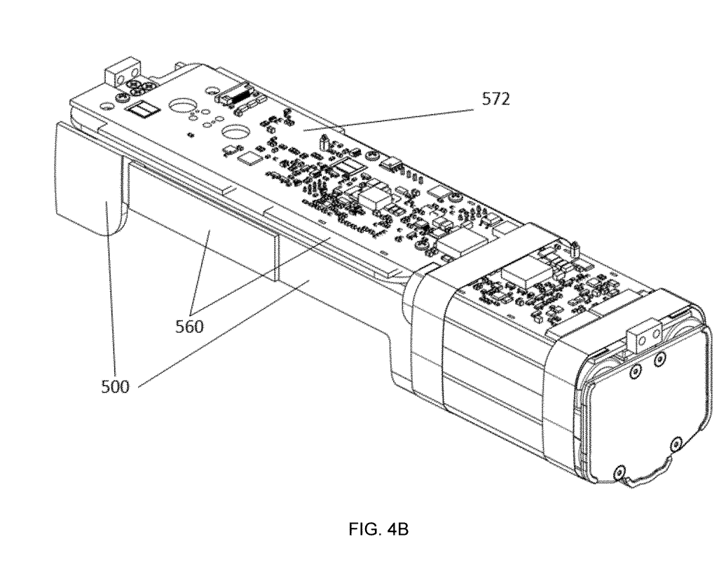

Turning now to FIG. 4A, the device can include a skeleton bracket 500. The skeleton bracket 500 can have one or more compartments 550 to house the rechargeable batteries.

In particular, a first compartment at a first end of the skeleton bracket can house one or more rechargeable batteries, and a second compartment at a second end of the skeleton bracket can house one or more rechargeable batteries. In this manner, the mass of the batteries is distributed thereby maintaining a central inertia of the device, so that the weight of the device is not disproportionately located at one end.

The skeleton bracket also provides a central structure for the top end bracket 504 and the bottom end bracket 502 to attach, which further provides a structure for the top housing assembly 300 and bottom housing assembly 200 to attach (see FIGS. 1A and 6A), structurally. Therefore, the skeleton bracket provides a central support structure to simultaneously house the batteries, connect the various parts, maintain structural integrity, and mount shock absorbing components, as described below.

Referring to FIGS. 4A and 4B, one or more shock absorbing layers 560, for example, shock absorbing strips of shock absorbing film such as poron film, can be disposed and fixed on a surface of the skeleton bracket, for example, by an adhesive. The dimensions of the shock absorbing strips is selectable by one skilled in the art based on routine experimentation.

Advantageously, the shock absorbing strips can be placed between the skeleton bracket and an interior surface of the housing to absorb shock between the housing and the internal components of the device. Similarly, the shock absorbing layers can be placed on or between various components, for example, between a BMS bracket 570 and a BMS PCB board 572, or between the inverter PCB 582 and the inverter heat sink 588.

Advantageously, the multi-layered design (for example, sandwiched components of the BMS PCB board 572, laying on the BMS bracket 570, laying on the skeleton bracket 500, laying on the inverter assembly 580) provides abundant locations to house shock absorbing strips in a manner that stacks shock absorbing layers along multiple axis.

Additionally, FIG. 5A shows a shock-cover 586, located over the inverter PCB 582, the cover being mechanically coupled, for example, by fasteners, to the inverter PCB and the inverter components to provide structural support for the inverter components. In other words, the cover is configured to absorb shock and reduce the stress to the inverter components.

The shock-cover can have openings 587, each sized for one of more relatively larger inverter components to pass through when positioned over the inverter PCB. The openings are configured to provide mechanical support to the larger components in forces (shock and/or vibration) parallel and/or transverse to the inverter PCB. In addition, the openings can have pockets 590 along their respective perimeters to house a flexible, shock absorbent sealant 589, for example, a silicone-based RTV. The shock absorbent material 589 can be disposed in spaces (for example, the pockets 690) between the cover and the relatively larger inverter components at the various openings, thereby providing additional support for the relatively larger inverter components.

In particular, during testing, the taller and/or larger components with larger mass were shown to exert stress and forces on the inverter PCB that resulted in broken electrical traces and other failures without such a shock-cover feature.

Referring to FIGS. 3A and 3B, the top housing assembly 300 can include an internal stiff body 304, for example, formed from a stiff plastic. Furthermore, the top housing assembly can have a soft outer layer 306 that covers the stiff body along the sides of the top housing, and importantly, extends along a top outer edge 308 of the top housing assembly and the device.

Similarly, as shown in FIG. 2B, the bottom housing assembly 200 can include an internal stiff body 204. The bottom housing assembly can have a soft outer layer 206 that covers the internal stiff body at sides of the bottom housing assembly, extending along a bottom outer edge 208.

The soft outer layer can, for example, be formed from a rubber, synthetic rubber, or silicon based polymer. Furthermore, the soft outer layer can be overmolded onto the respective stiff internal bodies to fix them in place and provide a durable and lasting connection between the internal bodies and the soft outer layers.

Advantageously, due to the tube-shaped geometry of the device, when dropped, the device will nearly always land along an outer edge 208 or 308 of the device, including corners along the edge. In other words, the device would have to land exactly parallel to a flat surface to not land. Therefore, although overmolded parts increase manufacturing complexity and costs, this soft outer layer is particularly advantageous to providing a shock-resistant device.

Furthermore, it is appreciated that a shock-absorbing, in this case, is particularly critical to maintain the shape and integrity of the various components of the device, thereby maintaining tolerances required for water-tight seals. In other words, if the device does not provide sufficient shock-absorbance, the parts will deform and increase the risk of water entering through cracks or deformities.

For example, during shock testing, the device was shown to successfully drop at 1 meter, in all six axis, with four cycles (24 total drops). The device was successfully dropped on top and bottom faces, every edge, and every corner.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure, and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

What is claimed is:

1. A portable energy storage device comprising:
a rechargeable battery system having one or more rechargeable batteries with a combined energy capacity of 40 Wh or more;
one or more input electrical connectors and one or more output electrical connectors; and
a water-resistant elongated tube-shaped housing, the housing having
a top end, a bottom end, and
a height that is at least three times that of a width and a length of the housing.

2. The device according to claim 1, wherein the width is between 2 and 3 inches and the length is between 2 and 3 inches.

3. The device according to claim 1, wherein the housing is a vent-less housing, without openings.

4. The device according to claim 1, wherein the top end and the bottom end of the housing includes a stiff body and a soft outer layer covering the stiff body at sides of the top end and bottom end.

5. The device according to claim 2, wherein
the top end and/or the bottom end of the housing includes potting zones and potting disposed in the potting zones, and
the potting zones are co-located with the one or more input electrical connectors and/or the one or more output electrical connectors, resulting in a water-tight and dust-resistant seal at the one or more input electrical connectors and/or the one or more output electrical connectors.

6. The device according to claim 1, wherein the housing comprises:
a central housing body, a top housing assembly, and a bottom housing assembly;
wherein
the top housing assembly connects to the central housing body at a top edge of the central housing body through a first water-tight connection; and
the bottom housing assembly connects to the central housing body at a bottom edge of the central housing body through a second water-tight connection.

7. The device according to claim 6, wherein
the top housing assembly and the bottom housing assembly each have respective soft covers that are partially fixed to the respective top housing assembly and bottom housing assembly and cover the one or more input electrical connectors and one or more output electrical connectors;
the soft covers being partially removable to provide access to the one or more input electrical connectors and the one or more output electrical connectors; and
the soft covers and the respective top and bottom housing assemblies having complimenting forms to provide a removable and attachable water-resistant seal through mating when pulled apart or pressed together.

8. The device according to claim 6, wherein the first and second first water-tight connections are gasket rings sandwiched respectively between the central housing body and the top housing assembly, and the central housing and the bottom housing assembly.

9. The device according to claim 1, wherein the cross-section of the elongated tube-shaped housing is rectangular with rounded corners, throughout the entire height of the device.

10. The device according to claim 1, further comprising:
a button assembly disposed on a button zone of the housing, the button assembly including a button membrane, a stiffening member, and one or more water-tight buttons;
wherein
the stiffening member has a ring shape, located along a perimeter of the button membrane;
the button zone has one or more openings through the housing, the openings located directly below the button assembly;
the one or more openings are in fluid connection with the one or more batteries;
the one or more openings are sized to provide an emergency pressure outlet; and
the button assembly is fastened to the housing with a breakaway fastener.

11. The device according to claim 1, wherein the battery system includes
a charge controller; and
a battery management system, the battery management system including a microprocessor or a programmable logic device, configured to manage and control a charging and discharging of the one or more batteries.

12. The device according to claim 1, wherein the one or more batteries includes eight 18650 batteries, having a total energy capacity of 85 Wh or more.

13. The device according to claim 1, further comprising an inverter assembly, the inverter assembly having a modified sinusoid inverter and an AC voltage output of 90 W or more.

14. The device according to claim 1, wherein
the one or more input electrical connectors includes a DC input receptacle and a USB type-C receptacle;
the one or more output electrical connectors include a first USB receptacle, a second USB receptacle, and a universal AC outlet socket; and
the one or more input electrical connectors and one or more output electrical connectors are disposed on the top end and bottom end of the housing.

15. The device according to claim 14, further comprising:
a USB type-C controller; and
an input MUX; and
wherein
the USB type-C controller is configured to monitor the DC input receptacle and command the input MUX to toggle an input to a DC charger between the DC input receptacle and the USB type-C receptacle.

16. The device according to claim 1, further comprising:
one or more shock absorbing layers, the shock absorbing layers being strips of shock absorbing film; and
a skeleton bracket, the one or more rechargeable batteries being fixed to the skeleton bracket;
wherein at least one of the one or more shock absorbing layers are disposed on a component within the device.

17. The device according to claim 1, further comprising:
an inverter assembly, the inverter assembly including an inverter printed circuit board having inverter components mounted on the printed circuit board; and
an inverter heat sink plate thermally connected to heat generating components of the inverter assembly;
wherein the inverter heat sink plate is a flat, elongated plate without fins.

18. The device according to claim 17, further comprising:
a flexible heat transfer sheet and one or more sheet stiffeners;
wherein:
the one or more sheet stiffeners are attached to a surface of the sheet;
the sheet is in direct thermal contact with the inverter heat sink plate; and
the sheet is in direct thermal contact with the housing.

19. The device according to claim 18, wherein the flexible heat transfer sheet is a graphite heat transfer sheet.

20. The device according to claim 18, further comprising:
a shock cover, located over the inverter PCB, the cover being mechanically coupled to the inverter PCB and the inverter components to provide structural support for the inverter components, wherein
the cover has openings for one of more inverter components located on the inverter PCB, and flexible sealant or shock absorbent material is disposed in spaces between the cover and the inverter components at the openings.
